(19) United States
(12) Patent Application Publication
(10) Pub. No.: US 2006/0075787 A1
(43) Pub. Date: Apr. 13, 2006

(54) Apparatus and method for fabricating photonic crystral optical fiber preform

(75) Inventors: Soon-Jae Kim, Gumi-si (KR); Keun-Deok Park, Busan (KR)

Correspondence Address: CHA & REITER, LLC, 210 ROUTE 4 EAST STE 103, PARAMUS, NJ, 07652, US

(73) Assignee: Samsung Electronics Co., LTD

(21) Appl. No.: 11/216,311

(22) Filed: Aug. 31, 2005

(30) Foreign Application Priority Data
Sep. 24, 2004 (KR) 2004-77246

(51) Int. Cl. C03B 37/016

(52) U.S. Cl. 65/395

(57) ABSTRACT

Disclosed is an apparatus for fabricating a preform used to manufacture a photonic crystal optical fiber having multiple holes extending in a longitudinal direction thereof. The apparatus includes a housing for containing a raw material for the photonic crystal optical fiber; a first support member positioned at one end of the housing; a second support member positioned at the other end of the housing; and multiple tubes respectively supported by the first and second support members to be at least partly located within the housing, wherein diameter of each multiple tube can be variable selectively depending on an amount of fluid poured through the open ends of the tubes.

### CLAIM OF PRIORITY

This application claims priority to an application entitled “Apparatus for Fabricating Photonic Crystal Optical Fiber Preform,” filed with the Korean Intellectual Property Office on Sep. 24, 2004 and assigned Serial No. 2004-77246, the contents of which are hereby incorporated by reference.

### BACKGROUND OF THE INVENTION

1. Field of the Invention

The present invention relates to a photonic crystal optical fiber, and in particular to an apparatus for fabricating a photonic crystal optical fiber preform.

2. Description of the Related Art

A photonic crystal optical fiber is fabricated from a transparent glass material and has multiple holes which extend in a longitudinal direction thereof. Propagation of an optical signal in such a photonic crystal optical fiber occurs by a photonic band-gap effect and an effective index, which is discussed in detail by T. A. Birks et al. in Electronic Letters, Vol. 31(22) p. 1941 (October 1995) and by J. C. Knight et al. in Proceeding of OFC, PD 3-1 (February 1996).

In the prior art, a glass stacking method, a glass drilling method, a sol-gel method, etc. are available as means for fabricating a photonic crystal optical fiber preform. The glass stacking method involves fabricating a photonic crystal optical fiber by repeatedly performing the steps of stacking, bundling, and elongating multiple glass tubes. The glass drilling method requires forming of multiple holes in a glass rod by drilling. The sol-gel method includes the steps of: positioning multiple pins in a hollow cylindrical mold, pouring liquefied sol into the mold, converting the sol into gel state, and then releasing the gel from the mold. Then, a series of processes including a drying process, a low-temperature heat treatment process, and a sintering process are performed to the released gel to obtain a photonic crystal optical preform. The characteristics of such a photonic crystal optical fiber obtained by melting the preform is mainly determined by an air filling factor (AFF), which indicates a ratio of a diameter of a hole to a distance between the centers of adjacent holes.

However, as the conventional sol-gel methods employ pins having a constant diameter for forming the opening of the photonic crystal optical preform, there are drawbacks in that it is difficult to optionally set the diameter of each hole and the wall thickness between holes (that is, it is difficult to optionally set an AFF). Further, the shape of gel is frequently collapsed during the process of removing the pins if the holes are closely positioned, or if the wall thickness between the holes are thin.

### SUMMARY OF THE INVENTION

Accordingly, the present invention has been made to solve the above-mentioned problems occurring in the prior art and provides additional advantages, by providing an apparatus and method for fabricating a photonic crystal optical fiber preform, which allows the diameter of a hole to be adjusted selectively and in which gel is released easily.

In one embodiment, there is provided an apparatus for fabricating a preform for a photonic crystal optical fiber having multiple holes extending in a longitudinal direction thereof which includes: a housing for containing a raw material for the photonic crystal optical fiber; a first support member positioned at one end of the housing; a second support member positioned at the other end of the housing; and multiple tubes respectively supported by the first and second support members to be at least partly located within the housing, wherein each of the multiple tubes has one open end and the portions of the tubes located within the housing are variable in diameter depending on the pressure of fluid poured through the open ends of the tubes.

### BRIEF DESCRIPTION OF THE DRAWINGS

The above features and advantages of the present invention will be more apparent from the following detailed description taken in conjunction with the accompanying drawings, in which:

FIG. 1 is a cross-sectional view of a photonic crystal optical fiber preform according to an embodiment of the present invention;

FIG. 2 is a vertical sectional view of an apparatus for fabricating a photonic crystal optical fiber according to an embodiment of the present invention;

FIG. 3 is a top plan view of the fabrication apparatus of FIG. 2 in a state in which first and third pouring tube units are removed;

FIG. 4 is a top plan view of the fabrication apparatus of FIG. 2 in a state in which the first pouring tube unit is connected to a first support plate;

FIG. 5 is a perspective view of the first pouring tube unit;

FIG. 6 is a top plan view of the apparatus shown in FIG. 2 in a state in which the second pouring tube unit is connected to the first support plate; and

FIG. 7 is a top plan view of the apparatus shown in FIG. 2 in a state in which the third pouring tube unit is connected to the first plate.

### DETAILED DESCRIPTION

Hereinafter, embodiments of the present invention will be described with reference to the accompanying drawings. For the purposes of clarity and simplicity, a detailed description of known functions and configurations incorporated herein will be omitted as it may make the subject matter of the present invention unclear.

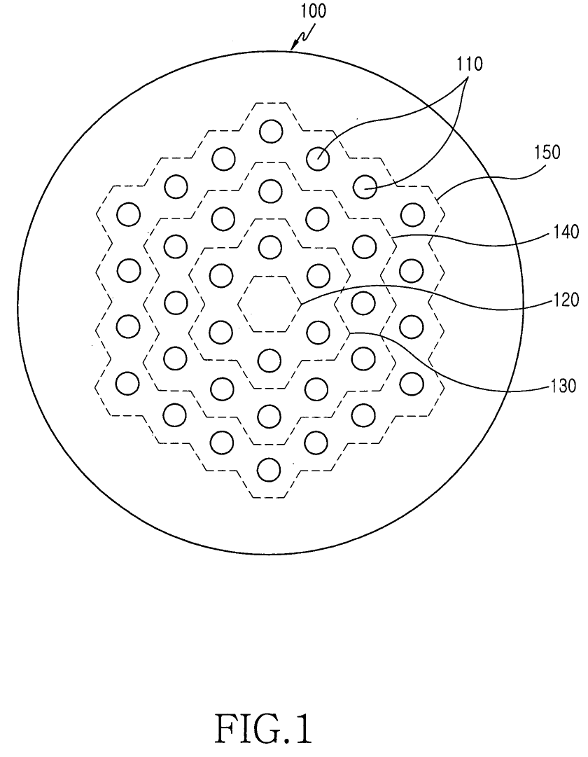

FIG. 1 shows a photonic crystal optical fiber preform according to an embodiment of the present invention. As shown, the preform 100 is formed generally in a cylindrical rod shape from a glass material and has multiple cylindrical holes 110 extending therethrough in a longitudinal direction. The holes 110 are arranged around a core region positioned at the center of the preform. In particular, the holes 110 are arranged in a three-ply arrangement around the core region, in which each ply takes a form of regular hexagonal. The first ply 130 surrounding the core region consists of six holes 110, the second ply 140 surrounding the first ply 130 consists of twelve holes 110, and the third ply 150 surrounding the second ply 140 consists of eighteen holes 110. The number of the plies of the holes 110 can be selectively increased or decreased, and each ply may be in a form of square shape.

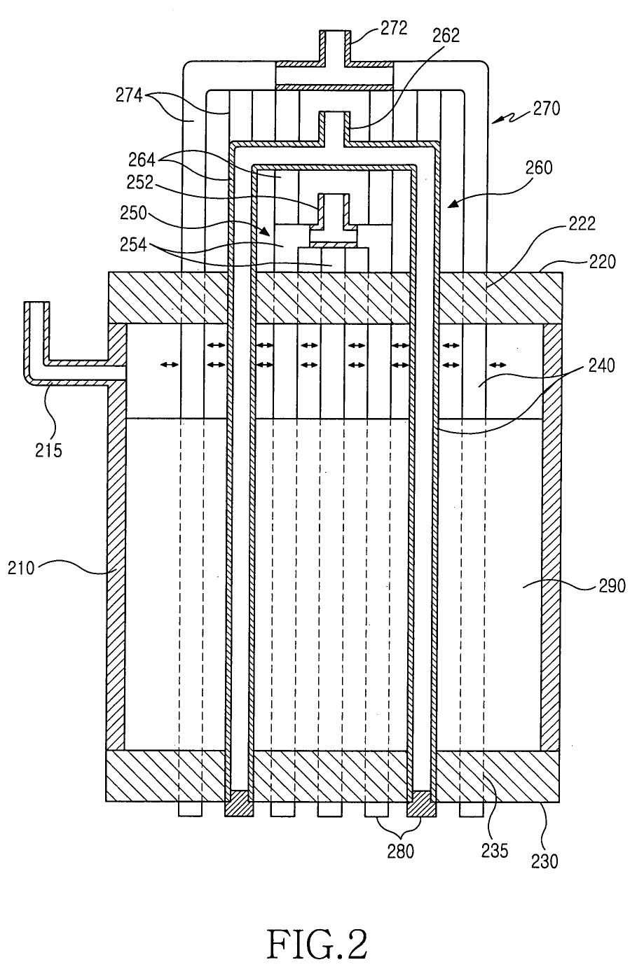

FIG. 2 shows an apparatus for fabricating a photonic crystal optical fiber preform according to an embodiment of the present invention. As shown, the fabrication apparatus 200 includes a molding means used in the gelling process during fabrication according to a sol-gel method. In particular, the fabrication apparatus 200 includes a housing 210, first and second supporting members 220, 230, multiple tubes 240, and first to third pouring tube units 250, 260, 270.

The housing 210 is in a cylindrical tubular shape having opened opposite ends and contains sol 290, which is the raw material of a photonic crystal optical fiber preform. The housing 210 has a sol pouring spout 215 on its upper part for receiving the sol 290 from the outside. The sol spout 215 takes a form of elbow with a cylindrical tube, wherein one open end of the spout is externally exposed and the other open end is exposed within the housing 210. The sol 290 is filled to the bottom of the housing 210 through the sol pouring spout 215.

The first support member 220 is positioned on the open top end of the housing 210 and is in a form of circular plate having multiple cylindrical holes 222. The first support member 220 closes the top open end of the housing, and the arrangement of the holes 222 are identical to that of the holes 110 shown in FIG. 1.

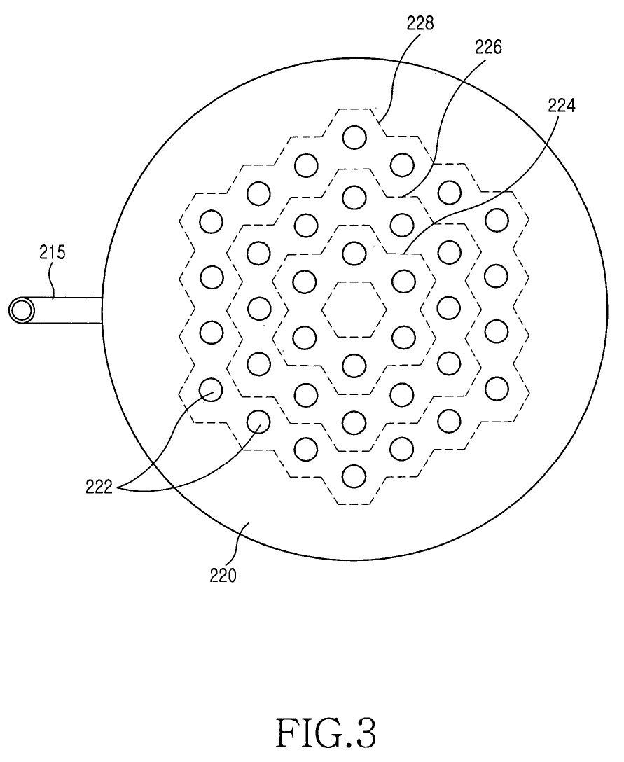

FIG. 3 is a top plan view showing the fabrication apparatus 200 in a state in which the first to third pouring tube units 250, 260, 270 are removed. As shown, the first support member 220 has multiple holes 222 arranged around the core area located at the center of the first support member 220 to form multiple plies 224, 226, 228. In particular, the holes 222 are arranged in a three-ply arrangement around the core area with each ply having a hexagonal form. The first ply 224 surrounding the core area consists of six holes 222, the second ply 226 surrounding the first ply 224 consists of twelve holes 222, and the third ply 228 consists of eighteen holes 222. It should be noted that number of holes in FIG. 3 is shown for illustrative purposes. Thus, the number of holes should not limit the scope of the present invention.

Returning back to FIG. 2, the second support member 230 is located at the bottom open end of the housing 210 and is in a form of circular plate having multiple cylindrical holes 235. The second support member 230 has a same form as the first support member 220, and the holes 230 in the second support member 230 are vertically aligned with the holes 222 in the first support member 220. As the second support member 230 covers the bottom open end of the housing 210, the sol 230 flowed into the interior of the housing 210 through the sol pouring spout 215 is contained in the housing.

The multiple tubes may be cylindrical tubes each formed from an easily bendable and diametrically expandable and shrinkable material, for example, cylindrical rubber tubes. Each tube 240 is inserted into and supported by a corresponding pair of vertically aligned holes in the first and second support members 220, 230, at the opposite ends thereof. In order to facilitate the release of gel, the top end of each tube 240 may be attached to the inner periphery of a corresponding hole in the first supporting member 220 while the lower end of the tube 240 may be inserted into a corresponding hole in the second supporting member 230. The tubes 240 may be arranged in a three-ply arrangement around the core area similar to the arrangements of holes in the first support plate 220 and the second support plate 230, with each ply taking a hexagonal form.

For example, the first ply surrounding the core area consists of six tubes 240, the second ply surrounding the first ply consists of twelve tubes 240, and the third ply surrounding the second ply consists of eighteen tubes 240. Each tube is sealed by a corresponding stopper 280 at the lower end thereof. The portion of the tube located between its opposite ends supported by the holes, i.e., the portion positioned within the housing 210 may be variable in diameter depending on the pressure of the fluid introduced through the open top end thereof.

By curing the sol 290 contained in the housing 210 in a state in which the diameter of the tube 240 has been changed to a preset diameter, it is possible to obtain a gel having multiple holes each having a preset diameter. Hence, it is possible to optionally set the diameter of each hole formed in the gel and the wall thickness between the holes. In addition, the stress applied to the walls between the holes in the process of releasing the tubes 240 can be minimized by employing the tubes 240 formed from a freely bendable material. Further, it is possible to reduce the wall thickness. The shape of the gel is identical to that of the preform shown in FIG. 1, and subsequently by performing a drying process, a low-temperature heat treatment process and a sintering process to the gel, a preform 100 as shown FIG. 1 can be obtained.

The first to third pouring tube units 250, 260, 270 are fixed to the top surface of the first support member 220 such that they are connected to the holes 222 in the first support member 220, and fluid is supplied to the tubes 240 through the first to third pouring tube units 250, 260, 270. The first to third pouring tube units 250, 260, 270 respectively consist of cylindrical tube shaped pouring spout 252, 262, 272 and elbow-shaped cylindrical tubes 254, 264, 274 radially extending to communicate with the cylindrical tube shaped pouring spouts 252, 262, 272. The tubes 254, 264, 274 are connected to and communicate with the pouring spouts 252, 262, 272, and the tip ends of the tubes 254, 264, 274 are respectively connected to corresponding holes 222 in the first support member 220 to communicate with corresponding tubes 240.

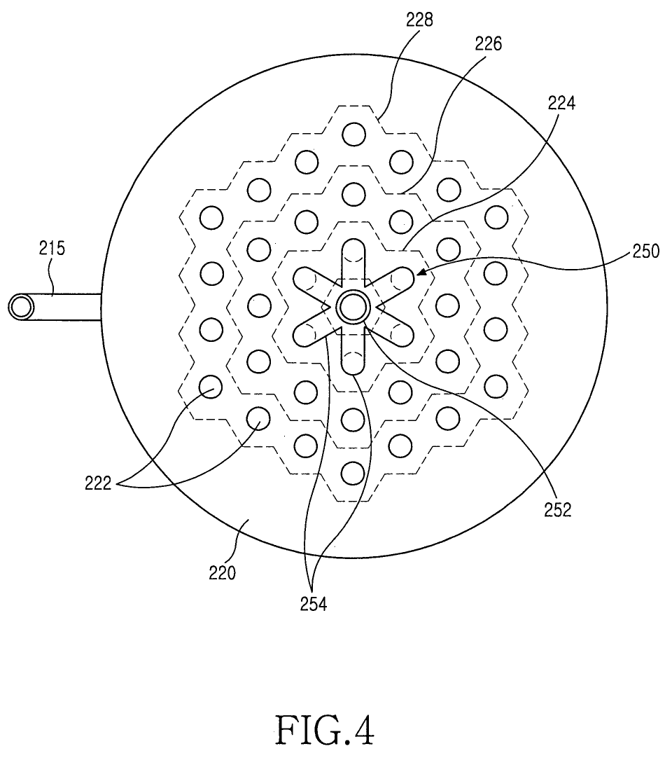

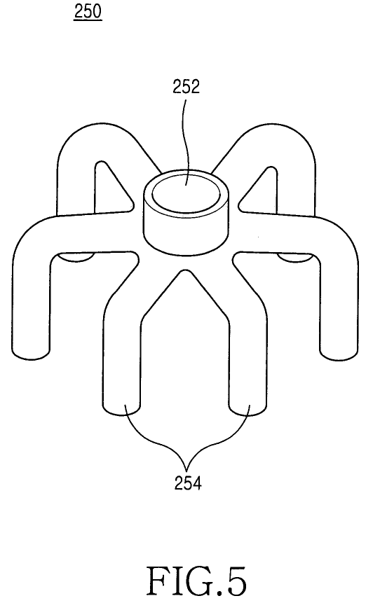

FIG. 4 is a top plan view showing the connection state of the first pouring tube unit 250 to the first support plate 220, and FIG. 5 is a perspective view showing the first pouring tube unit 250. As shown, the tip ends of the six tubes 254 of the first pouring tube unit 250 are connected to the holes 222 of the first ply 224 in the first plate 220. Each tube 254 of the first pouring tube unit 250 is extended in the diametrical direction of the pouring spout 252 and then downwardly bent in the longitudinal direction of the pouring spout 252.

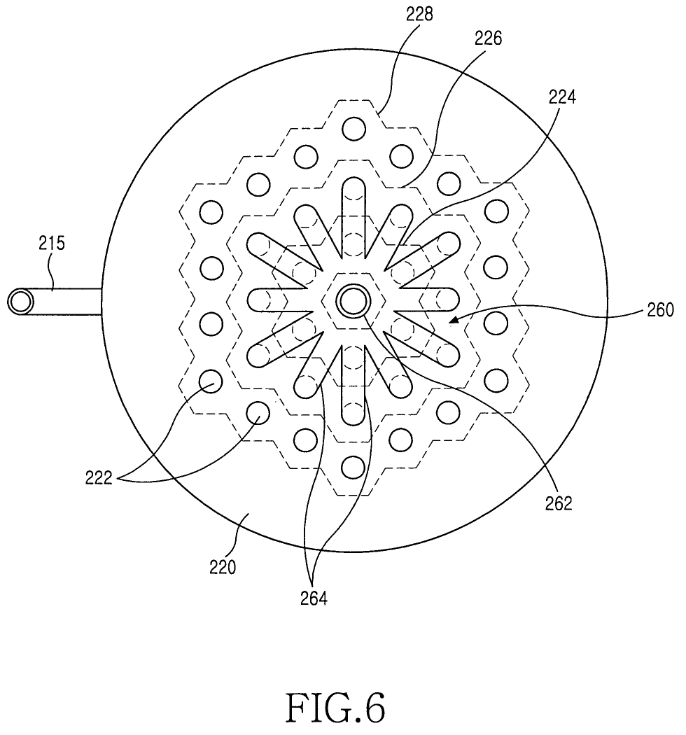

FIG. 6 is a top plan view showing the connection state of the second pouring tube unit 260 to the first support plate 220. As shown, the tip ends of the twelve tubes 264 of the second pouring tube unit 260 are connected to the holes 222 of the second ply 226 in the first support plate 220. Although not shown in FIG. 6, the second pouring tube unit 260 covers the first pouring tube unit 250.

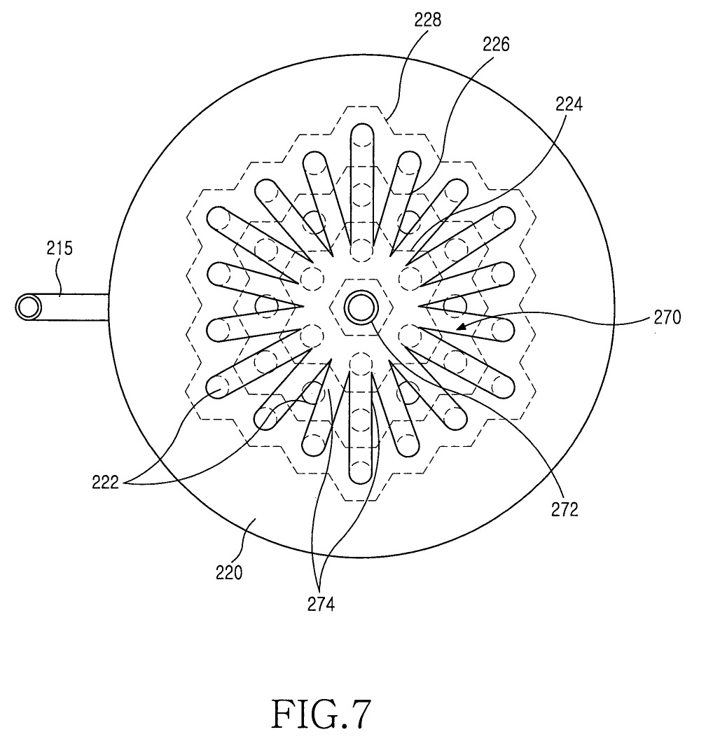

FIG. 7 is a top plan view showing the connection of the third pouring tube unit 270. As shown, the tip ends of the eighteen tubes 274 of the third pouring tube unit 270 are connected to the holes 222 of the third ply 228 in the first support plate 220. Although not shown in FIG. 7, the third pouring tube unit 270 covers the second pouring tube unit 260.

Now, the processes of forming gel using the fabrication apparatus 200 and releasing the gel are described hereinafter with reference to FIG. 2.

First, fluid is poured into the pouring spouts 252, 262, 272 of the first to third pouring tube units 250, 260, 270 to expand each tube 240 to a predetermined diameter. At this time, by selectively adjusting the amount of the fluid pouring into each of the first to third pouring tube units 250, 260, 270, it is possible to make the tubes 240 of the first to third plies have different diameters from each other, or to make the tubes 240 of any one ply have a diameter different from the remaining tubes.

Next, sol 290 is poured into the sole pouring spout 215 to be filled within the housing 210 to a preset height from the bottom of the housing 210.

Then, if the gelling process of the sol 290 is completed, the fluid in the tubes 240 are removed through the pouring spouts 252, 262, 272 of the first to third pouring tube units 250, 260, 270, thereby allowing the tubes 240 to shrink to the state prior to expansion.

Then, the stoppers 280 connected to the lower ends of the tubes 240 are removed.

Then, the housing 210 is lifted upwardly to release the gel from the housing 210.

Thereafter, by performing a drying process, a low-temperature heat treatment process, a sintering process, etc. to the released gel, a preform 100 as shown in FIG. 1 can be obtained.

As described above, the inventive apparatus for fabricating a photonic crystal optical preform has an advantage in that the diameters of holes formed in gel and the wall thickness (of AFF) between holes can be optionally set by employing expandable and shrinkable tubes, and in that the wall thickness between the holes can be reduced as compared to the prior art by minimizing the stress developed between the holes and tubes.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. An apparatus for fabricating a preform used to produce a photonic crystal optical fiber having multiple holes extending in a longitudinal direction thereof, comprising:
a housing for housing a raw material used to produce the photonic crystal optical fiber;
a first support member disposed at a substantially horizontal orientation at one end of the housing;
a second support member disposed at a substantially horizontal orientation at the other end of the housing; and
a plurality of multiple tubes supported by the first and second support members to be at least partly located within the housing, wherein each of the multiple tubes has one open end and the portions of the tubes located within the housing are variable in diameter depending on a pressure of fluid poured through the open ends of the tubes.

2. An apparatus as claimed in claim 1, further comprising:
at least one pouring tube unit coupled to openings formed in the first support member so as to supply the fluid into the tubes.

3. An apparatus as claimed in claim 2, wherein the pouring unit comprises:
a pouring spout for receiving the fluid; and
multiple tubes radially extending from the pouring spout to communicate with the pouring spout.

4. An apparatus as claimed in claim 1, wherein the first and second support members respectively provide vertically aligned multiple pairs of openings so that the tubes are inserted into and supported by corresponding opening pairs at the opposites ends thereof.

5. An apparatus as claimed in claim 4, wherein the first and second support members respectively comprise multiple openings arranged in a multiple-ply arrangement.

6. An apparatus as claimed in claim 5, further comprising multiple pouring tube units coupled to the openings of the corresponding plies, respectively, to supply the fluid to the tubes.

7. An apparatus as claimed in claim 5, wherein each of the pouring tube unit comprises:
a pouring spout for introducing the fluid; and
multiple tubes radially extending from the pouring spout to communicate with the pouring spout.

8. A method for fabricating a preform used to produce a photonic crystal optical fiber having multiple holes extending in a longitudinal direction thereof, the method comprising the steps of:
providing a plurality of expandable tubes in a substantially vertical orientation in a housing;
selectively pouring a fluid into the expandable tubes to expand each tube to a predetermined diameter;
providing a sol into the housing and performing a gelling process of the sol;
removing the fluid from the expandable tubes; and
removing the housing to release the gel.

9. The method of claim 8, wherein an amount of the fluid poured into the expandable tubes is selectively adjusted to control the diameter of each expandable tube.

10. The method of claim 8, further comprising the step of performing a drying process, a low-temperature heat treatment process, a sintering process to the released gel to obtain the preform.
